(19) United States
(12) Patent Application Publication
(10) Pub. No.: US 2019/0394163 A1
(43) Pub. Date: Dec. 26, 2019

(54) SYSTEM AND METHOD FOR MANAGING FILE ACCESS

(71) Applicant: American Megatrends International, LLC, Norcross, GA (US)

(72) Inventor: Terry Yukio Otsubo, Duluth, GA (US)

(21) Appl. No.: 16/558,775

(22) Filed: Sep. 3, 2019

Related U.S. Application Data
(63) Continuation-in-part of application No. 15/333,760, filed on Oct. 25, 2016.
Application No. 15/333,760 is a continuation-in-part of application No. 15/491,829, filed on Apr. 19, 2017.
Application No. 15/491,829 is a continuation of application No. 15/333,760, filed on Oct. 25, 2016.

(51) Int. Cl. H04L 29/12; H04L 29/08; G06F 16/951; G06F 16/955

(52) U.S. Cl. CPC H04L 61/1582; H04L 67/06; H04L 67/02; G06F 16/9566; G06F 16/951

(57) ABSTRACT

Systems and methods for managing access of one or more files at a web server are provided. A computing device is provided as the web server, which has a file system storing multiple files. Each file is designated as a public file or a non-public file. Each non-public file is assigned with an access level. When the web server receives a URL entry, the web server determines whether the URL entry includes a valid query string, which includes a query symbol followed by text indicating a request filename. If so, the web server queries the file system for a matching file having the request filename. If the matching file is a public file, access to the public file is granted. If the matching file is a non-public file, access to the non-public file is then determined based on the access level of the non-public file.

### CROSS-REFERENCE TO RELATED APPLICATIONS

This application is a continuation-in-part of U.S. patent application Ser. No. 15/333,760, filed Oct. 25, 2016, and patent application Ser. No. 15/491,829, filed Apr. 19, 2017, which itself is a continuation application of U.S. patent application Ser. No. 15/333,760, filed Oct. 25, 2016. The disclosure of the above applications are incorporated herein in their entireties by reference.

### FIELD

The present disclosure relates generally to computer file management technology, and more particularly to systems and methods for managing access of one or more files at a web server.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Typically, a file on a web server is provided with a hyperlink, which allows a website content administrator (admin) to provide a download to a file using the hyperlink on a website to a web guest (or user). For example, the user may browse a website, which provides the hyperlink to the file. The management of the files can be challenging because the admin has to know both the name (filename) and the location (or path) of the file in order to provide the hyperlink of the file at the website, especially if the website has many sites and/or content and if the website changes frequently. The admin may not know the path of the file because the admin may not have full access rights to the file system on the web server and therefore would not know where files are stored and/or where to put (or upload) the file. An admin may inadvertently change the file naming scheme and/or filename of an existing file, which is problematic if a link to that file is located on a web server not managed, owned and/or operated by the admin. This is also problematic if multiple links to the file exist on a web server managed by the admin. All existing download links will no longer be able to direct users to the file until the URL is updated with the updated filename. Users trying to access (or download) a file from such a link will result in a file not found error.

This occurs because human nature is to do things in a way that takes the least amount of effort and energy. Typically, if a filename is FILE.DOC, the admin will upload the file as FILE.DOC. If the file is updated and is now FILE-NEW.DOC, the admin will delete FILE.DOC and upload FILE-NEW.DOC. This is problematic because websites can have multiple admins and the admin will only update links to that file that the admin is aware of and/or remembers.

These combination of factors lead to an unstable filename, which lead to an unstable link to the file, which results in file not found errors, which create a bad user experience and both, unhappy users and admins.

Therefore, an unaddressed need exists in the art to address the aforementioned deficiencies and inadequacies.

### SUMMARY

Certain aspects of the disclosure direct to a method, which includes: providing a computing device functioning as a web server, the web server having a file system storing a plurality of files, wherein each of the files in the file system has a stable filename, and is designated as a public file or a non-public file, and each of the non-public files is assigned with an access level; receiving, at the web server, a uniform resource locator (URL) entry from an internet browser, wherein the internet browser is executed on a remote computing device communicatively connected to the web server via a network; determining whether the URL entry includes a valid query string, wherein the valid query string includes a query symbol followed by text indicating a request filename; and in response to determining that the URL entry includes the valid query string, querying the file system as a data source for a matching file having the request filename; determining the matching file as either the public file or the non-public file; in response to determining the matching file as the public file, granting access to the public file to the internet browser; and in response to determining the matching file as the non-public file, determining the access level of the non-public file, and granting or denying access of the file to the internet browser based on the access level of the non-public file.

In certain embodiments, the method further includes: receiving, at the web server, a web request including a hyperlink directed to one of the files stored in the file system; in response to receiving the web request, determining whether the one of the files directed by the hyperlink is the public file or the non-public file; in response to determining the one of the files is the public file, granting access of the public file; and in response to determining the one of the files is the non-public file, denying access of the non-public file.

In certain embodiments, the method further includes: receiving, at the web server, an uploaded file; storing the uploaded file as one of the files in the file system of the web server, and designating the uploaded file as the public file or the non-public file; and in response to designating the uploaded file as the non-public file, assigning the access level to the non-public file.

In certain embodiments, the method further includes: in response to receiving the upload file, process the filename of the file such that the processed filename of the file is URL friendly and stable.

In certain embodiments, for each of the files being designated as the non-public file, the access level of the non-public file is selected from one of the following levels: (1) partially restricted, indicating that the non-public file is accessible only under one or more restricted conditions; and (2) completely restricted, indicating that the non-public file is not accessible.

In certain embodiments, the one or more restricted conditions include a special condition, indicating that the non-public file is accessible only by approval to a download request.

In certain embodiments, the method further includes: in response to determining that the non-public file is accessible under the special condition, displaying a download request form on the internet browser.

In certain embodiments, the one or more restricted conditions include a user authentication condition, indicating that the non-public file is accessible only by an authenticated user.

In certain embodiments, the method further includes: in response to determining that the non-public file is accessible under the user authentication condition, displaying an authentication page on the internet browser.

In certain embodiments, the one or more restricted conditions include a location condition, indicating that the non-public file is accessible only by a user from predetermined locations.

In certain embodiments, the method further includes: determining, based on location information in the URL entry, whether the user is from one of the predetermined locations; in response to determining that the user is from the predetermined locations, granting access of the non-public file; and in response to determining that the user is not from the predetermined locations, denying access of the non-public file.

Certain aspects of the disclosure direct to a system, which includes a computing device functioning as a web server, the computing device comprising a processor, a storage device having a file system storing a plurality of files, and a memory storing computer executable code, wherein each of the files in the file system has a filename, and is designated as a public file or a non-public file, and each of the non-public files is assigned with an access level. The computer executable code, when executed at the processor, is configured to: receive a uniform resource locator (URL) entry from an internet browser, wherein the internet browser is executed on a remote computing device communicatively connected to the web server via a network; determine whether the URL entry includes a valid query string, wherein the valid query string includes a query symbol followed by text indicating a request filename; and in response to determining that the URL entry includes the valid query string, query the file system as a data source for a matching file having the request filename; determine the matching file as either the public file or the non-public file; in response to determining the matching file as the public file, grant access to the public file to the internet browser; and in response to determining the matching file as the non-public file, determine the access level of the non-public file, and grant or deny access of the file to the internet browser based on the access level of the non-public file.

In certain embodiments, the web server is configured to, in response to receiving a web request including a hyperlink directed to one of the files stored in the file system, determine whether the one of the files directed by the hyperlink is the public file or the non-public file; in response to determining the one of the files is the public file, grant access of the public file; and in response to determining the one of the files is the non-public file, deny access of the non-public file.

In certain embodiments, the computer executable code, when executed at the processor, is further configured to: receive, at the web server, an uploaded file; store the uploaded file as one of the files in the file system of the web server, and designate the uploaded file as the public file or the non-public file; and in response to designating the uploaded file as the non-public file, assign the access level to the non-public file.

In certain embodiments, the computer executable code, when executed at the processor, is further configured to: in response to receiving the upload file, process the filename of the file such that the processed filename of the file is URL friendly and stable.

In certain embodiments, for each of the files being designated as the non-public file, the access level of the non-public file is selected from one of the following levels: (1) partially restricted, indicating that the non-public file is accessible only under one or more restricted conditions; and (2) completely restricted, indicating that the non-public file is not accessible.

In certain embodiments, the one or more restricted conditions include: a special condition, indicating that the non-public file is accessible only by approval to a download request; a user authentication condition, indicating that the non-public file is accessible only by an authenticated user; and a location condition, indicating that the non-public file is accessible only by a user from predetermined locations.

In certain embodiments, the computer executable code, when executed at the processor, is further configured to: in response to determining that the non-public file is accessible under the special condition, displaying a download request form on the internet browser.

In certain embodiments, the computer executable code, when executed at the processor, is further configured to: in response to determining that the non-public file is accessible under the user authentication condition, displaying an authentication page on the internet browser.

In certain embodiments, the computer executable code, when executed at the processor, is further configured to: determine, based on location information in the URL entry, whether the user is from one of the predetermined locations; in response to determining that the user is from the predetermined locations, grant access of the non-public file; and in response to determining that the user is not from the predetermined locations, deny access of the non-public file.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, wherein:

FIG. 1 schematically depicts an exemplary system according to certain embodiments of the present disclosure.

FIG. 2 schematically depicts electrical components an exemplary computing device according to certain embodiments of the present disclosure.

FIG. 3 schematically depicts a web server having a file download module according to certain embodiments of the present disclosure.

FIG. 4A depicts a flowchart of the file downloading process using the URL containing a query string according to certain embodiments of the present disclosure.

FIG. 4B depicts a flowchart of a file downloading process using a hyperlink to a file according to certain embodiments of the present disclosure.

FIG. 5 depicts an exemplary form utilized by a file download module according to certain embodiments of the present disclosure.

FIG. 6 depicts a flowchart of the file uploading process according to certain embodiments of the present disclosure.

FIG. 7A depicts an exemplary screen of a web browser screen for submitting a file query for download through a URL entry according to certain embodiments of the present disclosure.

FIG. 7B is an exemplary screen of a web browser screen for submitting a file query for download through an alternate URL entry according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The terms “chip” or “computer chip”, as used herein, generally refer to a hardware electronic component, and may refer to or include a small electronic circuit unit, also known as an integrated circuit (IC), or a combination of electronic circuits or ICs.

Certain embodiments of the present disclosure relate to computer technology. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Example embodiments of the systems and methods disclosed herein allow downloads to occur from any URL path in the domain. When a web guest (or user) accesses a website, the application layer reads the URL entered by the web guest. Based on the URL, the application layer checks for a URL string. If a URL string is found, the application layer determines if the URL string contains a file designation. If a file designation is found within the URL string, the application layer processes the request, which may include one or more of the following functions: verifies file, verifies type, determines access rights, determines storage location, determines requirements, allows download, restricts download, displays error message, and logs transaction.

In one aspect of the disclosure, a method includes: providing a computing device functioning as a web server, the web server having a file system storing a plurality of files, wherein each of the files in the file system has a filename, and is designated as a public file or a non-public file, and each of the non-public files is assigned with an access level; receiving, at the web server, a uniform resource locator (URL) entry from an internet browser, wherein the internet browser is executed on a remote computing device communicatively connected to the web server via a network; determining whether the URL entry includes a valid query string, wherein the valid query string includes a query symbol followed by text indicating a request filename; and in response to determining that the URL entry includes the valid query string, querying the file system as a data source for a matching file having the request filename; determining the matching file as either the public file or the non-public file; in response to determining the matching file as the public file, granting access to the public file to the internet browser; and in response to determining the matching file as the non-public file, determining the access level of the non-public file, and granting or denying access of the file to the internet browser based on the access level of the non-public file.

In another aspect of the disclosure, a system includes a computing device functioning as a web server, the computing device comprising a processor, a storage device having a file system storing a plurality of files, and a memory storing computer executable code, wherein each of the files in the file system has a filename, and is designated as a public file or a non-public file, and each of the non-public files is assigned with an access level. The computer executable code, when executed at the processor, is configured to: receive a uniform resource locator (URL) entry from an internet browser, wherein the internet browser is executed on a remote computing device communicatively connected to the web server via a network; determine whether the URL entry includes a valid query string, wherein the valid query string includes a query symbol followed by text indicating a request filename; and in response to determining that the URL entry includes the valid query string, query the file system as a data source for a matching file having the request filename; determine the matching file as either the public file or the non-public file; in response to determining the matching file as the public file, grant access to the public file to the internet browser; and in response to determining the matching file as the non-public file, determine the access level of the non-public file, and grant or deny access of the file to the internet browser based on the access level of the non-public file.

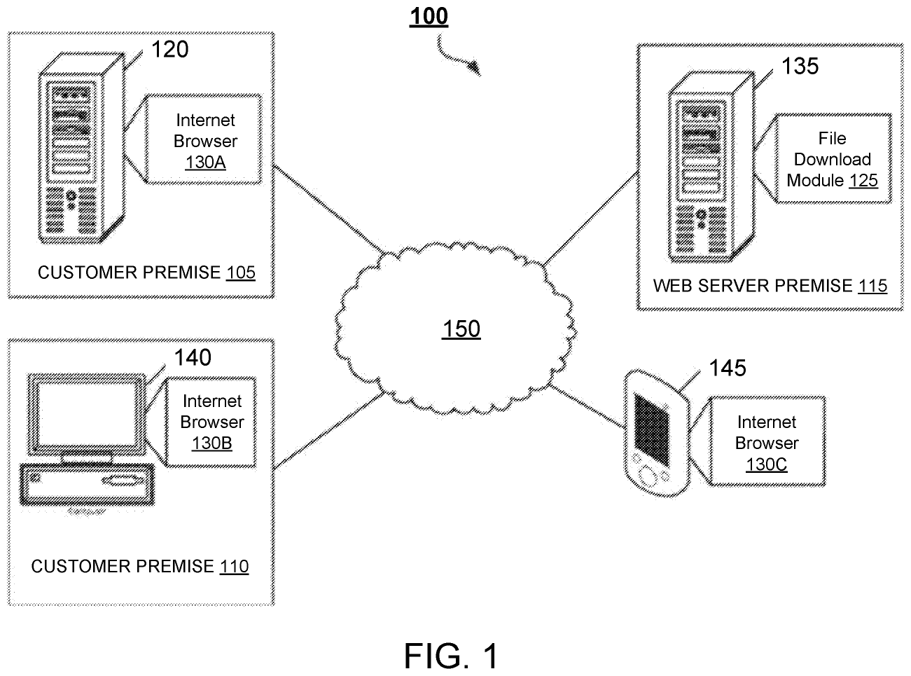

FIG. 1 schematically depicts an exemplary system according to certain embodiments of the present disclosure. As shown in FIG. 1, the system 100 generally includes at least one customer premise 105 that may include server 120 that runs internet browser 130A, at least one customer premise 110 that runs internet browser 130B on computer 140, at least one web server premise 115 that runs a file download module 125 on, for example, a computing device 135 functioning as the web server, and remote computing devices 145 that run internet browser 130C, that can all connect to the Internet. The premises 105, 110, server 115 and the remote computing devices 145 may be connected to network 150, such as the Internet, telephone network system, and cellular network system.

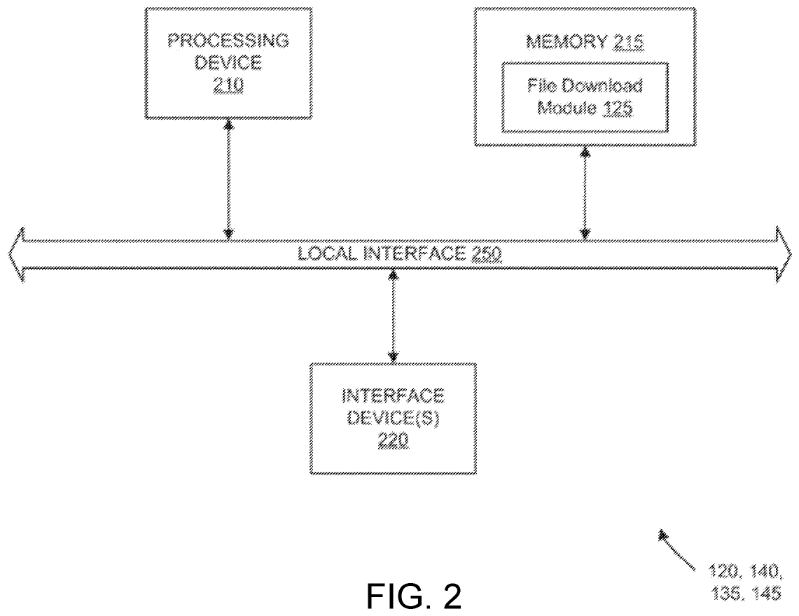

FIG. 2 schematically depicts electrical components an exemplary computing device according to certain embodiments of the present disclosure. Specifically, the computing device as shown in FIG. 2 may be used to implement any of the server 120, computer 140, web server 135, and remote computing device 145. As shown in FIG. 2, the computing device includes a processing device 210, a memory 215, in which the file download module 125 is stored, and one or more interface devices 220 that are connected to local interface 250 such that the processing device 210, the memory 215 and the interface device 220 may interface with each other.

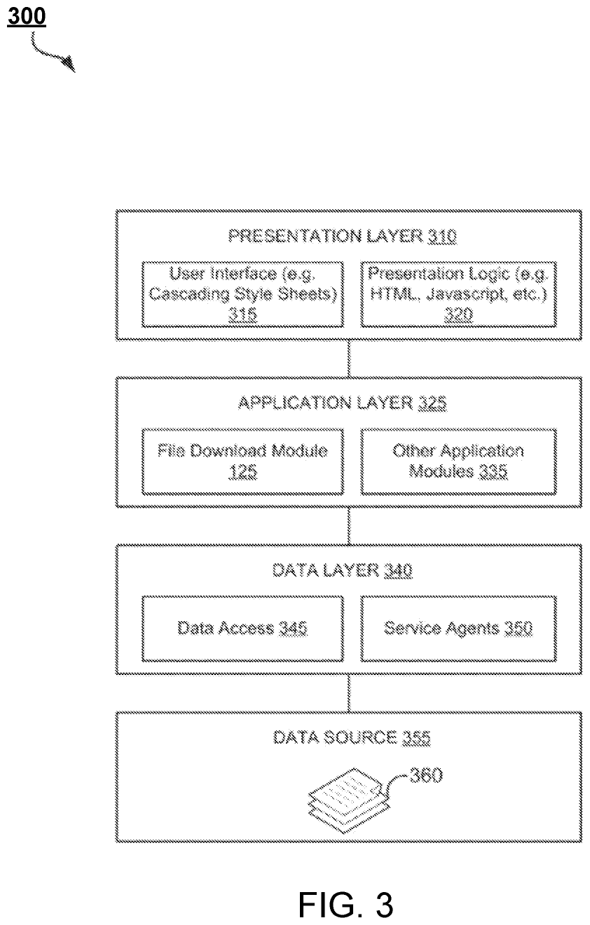

FIG. 3 schematically depicts a web server having a file download module according to certain embodiments of the present disclosure. Specifically, the web server 300 as shown in FIG. 3 may be an implementation of the web server 135 as shown in FIG. 1. As shown in FIG. 3, the web server 300 includes presentation layer 310, application layer 325, data layer 340, and data source 355. The presentation layer 310 includes User interface 315 and presentation logic 320. The user interface 315 configures the style of the user interface such as in cascading style sheets, as a non-limiting example. The presentation logic 320 includes the language used to present the user interface, such as HTML and Javascript as non-limiting examples. The application layer 325 includes file download module 325 and other application modules 335 such as, for example, user management module, page management module, event log viewer module, domain filter module, and reports module, among others. The data layer 340 includes data access module 345 and service agents 350. The data source 355 includes the source of data 360.

As discussed above, the systems and methods as disclosed herein utilize the query string to activate the application, in which the application layer reads the URL entry and checks whether a valid query string is contained therein. If the query string is found, the application layer processes the request based on the query string, and determines whether the file requested by the query string is accessible. It should be noted that, in addition to determining the accessibility of the file based on the designation of the file being a public file or a non-public file, additional access level may be assigned to the non-public file such that the non-public file may be provided with limited or restricted access under certain conditions.

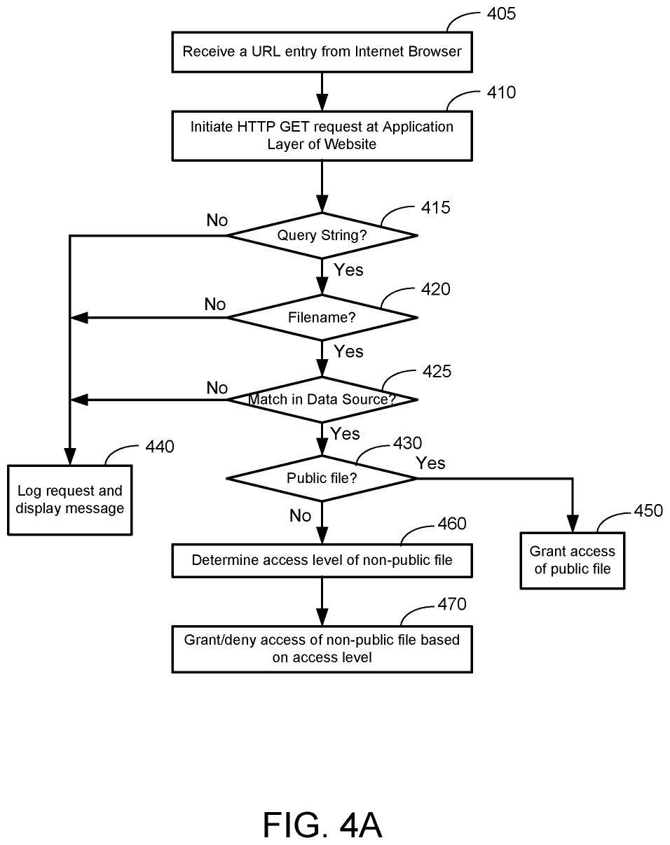

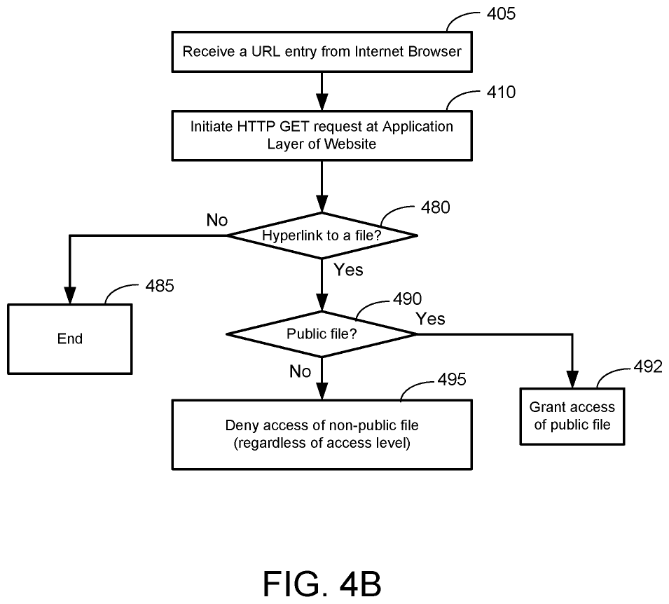

FIG. 4A depicts a flowchart of the file downloading process using the URL containing a query string according to certain embodiments of the present disclosure. In certain embodiments, the method as shown in FIG. 4A may be implemented by a system as shown in FIG. 1 and the web server as shown in FIG. 3 to download a file stored in a file system in the web server. It should be particularly noted that, unless otherwise stated in the present disclosure, the steps or procedures of the method may be arranged in a different sequential order, and are thus not limited to the sequential order as shown in FIG. 4A.

As shown in FIG. 4A, when a user intends to download a file, the user may input a URL entry through an Internet browser at the remote computing device. In certain embodiments, the input of the URL entry through an Internet browser at the remote computing device is typically performed for the user automatically when the user clicks on a link to the desired file. In block 405, the web server receives the URL entry. In block 410, an HTTP GET request is initiated at the application layer of the website. In block 415, a determination is made as to whether the URL entry contains a query string. Specifically, a valid query string is formed by a query symbol, which is a question mark “?”, followed by text indicating a request filename of the file. In this case, the determination is made by checking whether the URL entry includes the query symbol. If it does not, the process moves to block 440, where the request is logged and a message is displayed. If the request does contain a query symbol, then the process moves to block 420 in which a determination is made as to whether the query string contains the text indicating a request filename. If it does not contain any text that may resemble the filename, the process moves to block 440 where the request is logged and a message is displayed. If the query string does contain text that resembles a filename, it is determined that the URL entry includes a valid query string. In this case, the process moves to block 425 in which a determination is made as to whether the filename matches a file contained in the data source (i.e., the file system). If the filename does not match any file in the data source, then the process moves to block 440 where the request is logged and a message is displayed. If a matching file is found (i.e., the filename does match a file in the data source), then the process moves to block 430 in which a determination is made as to whether the file is a public file (i.e., a file accessible by the public) or a non-public file (i.e., a file with restrictions). If the file is designated as a public file, then, in block 450, access of the public file is granted, and a downloading process may be performed such that the user may download the public file. If the file is designated as a non-public file, then, in block 460, a further determination is made as to determine the access level of the non-public file, and in block 470, the access of the non-public file is either granted or denied based on the access level of the non-public file.

In certain embodiments, each of the files in the file system is assigned with a corresponding access level. For example, a file may be assigned with the access level as PUBLIC, indicating that the file is a public file, which is allowed to be downloaded by any user without restriction. On the other hand, for the non-public files, each non-public file may be further assigned with different access levels to indicate the different restriction conditions to each non-public file. For example, the access level of a non-public file can be categorized into two levels: (1) partially restricted, indicating that the non-public file is accessible only under one or more restricted conditions; and (2) completely restricted, indicating that the non-public file is not accessible. Examples of the restricted conditions may include, without being limited thereto, a special condition, indicating that the non-public file is accessible only by approval to a download request; a user authentication condition, indicating that the non-public file is accessible only by an authenticated user; a location condition, indicating that the non-public file is accessible only by a user from predetermined locations; or other restricted conditions that indicate the non-public file to be accessible when certain criteria is met.

For example, the partially restricted access level of a non-public file may include a SPECIAL level and a REGISTERED level. If the access level is SPECIAL, it is indicated that that the non-public file is accessible only by approval to a download request. In this case, the web server may direct the Internet browser to display a download request form, such that the user may place the download request through the form. If the access level is REGISTERED, it is indicated that that the non-public file is accessible only by an authenticated user. In this case, the user may be prompted to an authentication page, such that the user must log in first (or if logged in already) and is then able to immediately download the requested file.

On the other hand, the fully restricted access level of a non-public file may include one or more different conditions, under which the non-public file is not accessible. For example, the file may be subject to a non-disclosure agreement (NDA), or may be a file which is considered internal to a company that is not accessible on the Internet. In this case, the access level may be NDA or INTERNAL. In certain embodiments, when the access level of a non-public file being requested is NDA or INTERNAL, the user is prompted that the file does not exist and is sent to the homepage or resources page of the website.

As discussed above, the access level of a non-public file can be categorized into two levels: (1) partially restricted, indicating that the non-public file is accessible only under one or more restricted conditions; and (2) completely restricted, indicating that the non-public file is not accessible. When the web server receives a URL entry that contains a valid query string to request a non-public file, the file download module of the application may determine whether access of the non-public file should be granted or denied based on the access level of the non-public file. However, it should be noted that, when a file is provided in the file system of the web server, the file is provided with a hyperlink, and a user on the Internet may somehow obtain the hyperlink of the file and attempt to access the file using the hyperlink. In this case, all access to non-public files using the hyperlink should be denied, regardless of the access level of the non-public files.

FIG. 4B depicts a flowchart of a file downloading process using a hyperlink to a file according to certain embodiments of the present disclosure. In certain embodiments, the method as shown in FIG. 4B may be implemented by a system as shown in FIG. 1 and the web server as shown in FIG. 3 to download a file stored in a file system in the web server. It should be particularly noted that, unless otherwise stated in the present disclosure, the steps or procedures of the method may be arranged in a different sequential order, and are thus not limited to the sequential order as shown in FIG. 4B.

As shown in FIG. 4B, when a user intends to download a file, the user may input a URL entry through an Internet browser at the remote computing device. In certain embodiments, the input of the URL entry through an Internet browser at the remote computing device is typically performed for the user automatically when the user clicks on a link to the desired file. In block 405, the web server receives the URL entry. In block 410, an HTTP GET request is initiated at the application layer of the website. In block 480, a determination is made as to whether the URL entry is a web request contains a hyperlink directed to a file in the file system of the web server. Specifically, the hyperlink should include information indicating filename and a file path of the file in the file system, and thus should not include the query symbol. If the hyperlink does not exist in the URL entry, the process ends in block 485. If the hyperlink exists in the URL entry, in block 490, a determination is made as to whether the file is a public file (i.e., a file accessible by the public) or a non-public file (i.e., a file with restrictions). If the file is designated as a public file, then, in block 492, access of the public file is granted, and a downloading process may be performed such that the user may download the public file. If the file is designated as a non-public file, then, in block 495, access of the non-public file is denied, regardless of the access level of the non-public file. In other words, when the hyperlink is directly used in the attempt to access the non-public file, access to the non-public file is always denied.

As discussed above, for any non-public file in the file system of the web server, access of the non-public file will be denied if a user attempts to access the non-public file using the hyperlink directed to the non-public file. On the other hand, the access level of the same non-public file may be assigned as being partially restricted, indicating that the non-public file can be accessible using a URL entry having the query string under certain restricted conditions. In other words, certain embodiments of the disclosure allows the administrator to manage the files by assigning the access level of a non-public file as being partially restricted, such that the non-public file is not accessible using the hyperlink, but may be accessible using the query string.

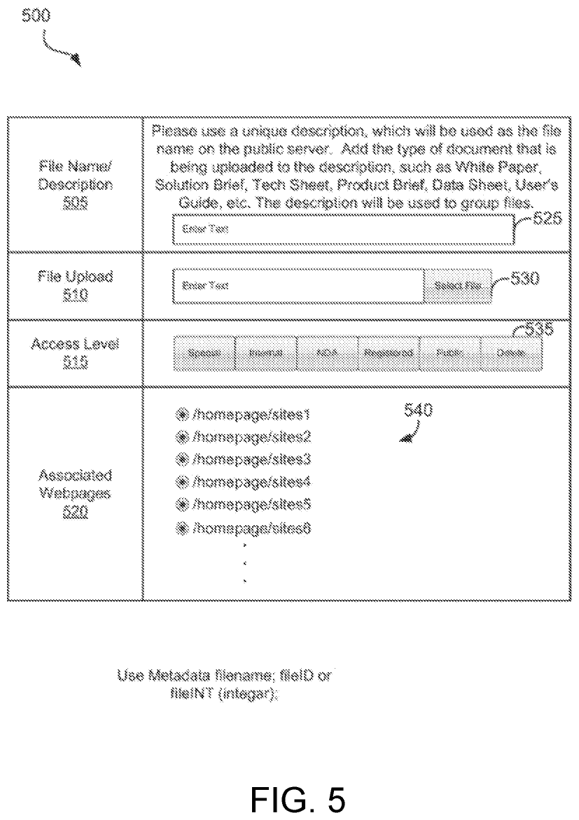

FIG. 5 depicts an exemplary form utilized by a file download module according to certain embodiments of the present disclosure. In an example embodiment, the form 500 includes file name/description field 505, file upload field 510, access level field 515, and associated webpages 520. File name description field 505 is used to enter a unique description of the file, which may be used as the file name on a server. The description may comprise the type of document that is being uploaded, such as White Paper, Solution Brief, Tech Sheet, Product Brief, Data Sheet, and User's Guide as non-limiting examples. In an example embodiment, the description is used to group files. File upload field 510 may include the actual filename, and the “select File” button may be selectable to Browse a file directory to choose the file by file name. When a particular file is chosen, the file name for that file may be populated into file upload field 510. Access level field 515 may comprise one or more selectable buttons for setting the access level of the selected file. Button selections may include “Special,” “Internal,” “NDA,” “Registered,” “Public,” and “Delete,” or other access levels as non-limiting examples. The delete selection may proscribe a special function for deleting the file from data source 355 of FIG. 3. Associated webpages field 520 may include additional URLs that are related to the file.

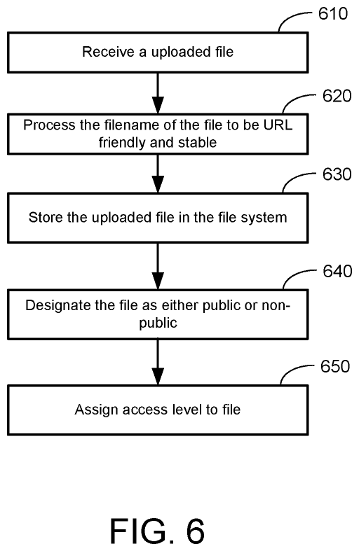

FIG. 6 depicts a flowchart of the file uploading process according to certain embodiments of the present disclosure. In certain embodiments, the method as shown in FIG. 6 may be implemented by a system as shown in FIG. 1 and the web server as shown in FIG. 3 to upload a file to be stored in a file system in the web server. It should be particularly noted that, unless otherwise stated in the present disclosure, the steps or procedures of the method may be arranged in a different sequential order, and are thus not limited to the sequential order as shown in FIG. 6.

As shown in FIG. 6, in block 610, a file is uploaded to the web server. In certain embodiments, the filename of the file may not necessarily follow the rules to be URL friendly, and thus may create potential problems in performing the file downloading process as discussed above. Thus, in block 620, the filename of the file is processed such that the processed filename of the file is URL friendly and stable. Specifically, by stating that the processed filename is “stable”, it generally means that the filename does not change even when the filename of the file is updated with a new file using a different filename. The benefit being that all links to the file will not break in the event of the file being updated with a new file. In other website content management systems (CMS) (such as WordPress), when an admin wants to replace an existing file, the admin must delete the file that the admin wants to replace. The admin then uploads the new file. A new link to the file is created using the filename of the uploaded file. If the filename of the uploaded file is the same as the filename of the original file, then all links to that file will send users to the new file. If the filename is different from the original filename, then the links to the file all break. Files cannot be stored in a file system using the same filename. Typically, admins do not discard of older files, but instead retained all versions of files using some form of version control. Because of this, the filename of new files are not identical to the original, and it is not typical for a filename to use the same filename as the file that is being replaced. Therefore, it is important to process the filename of the file to ensure that the filename becomes stable. Additionally, in block 620, no two files are permitted to have identical filenames. However, if the file is being updated or replaced with a new file, the same filename is used so that existing links to said file remain intact. Since no two files are permitted to have identical filenames, the original file will be overwritten with the updated file using the same filename. Thus, additionally, in block 620, the filename of the file is processed such that the processed filename of the file is stable.

In block 630, the file is stored in the file system. In block 640, the file is designated as a public file or a non-public file. In block 650, the file is assigned with a corresponding access level. In certain embodiments, only non-public files are assigned with the access levels. In certain embodiments, all files are assigned with the access levels.

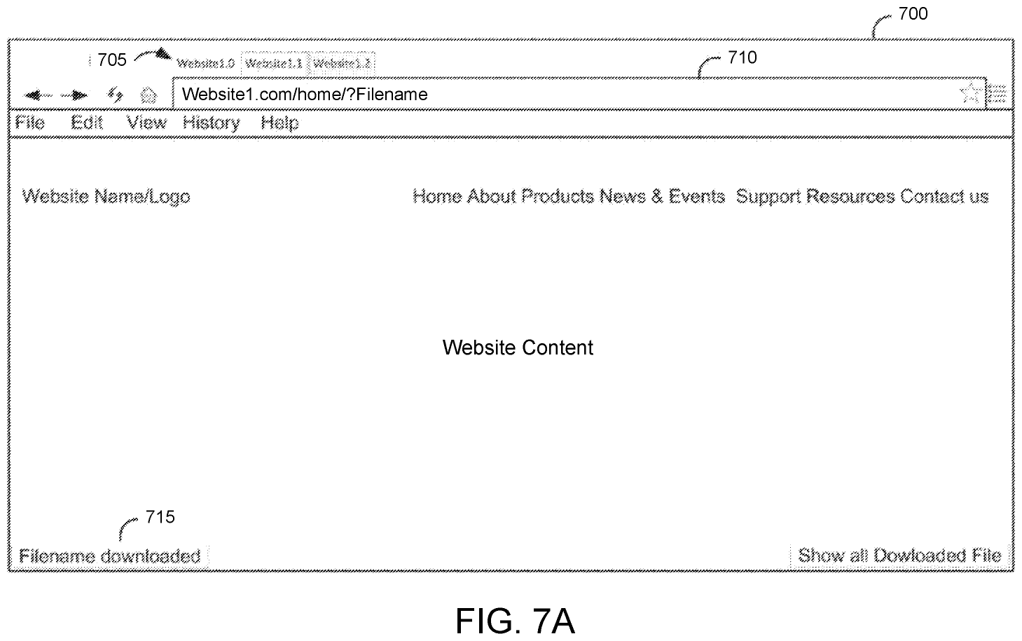

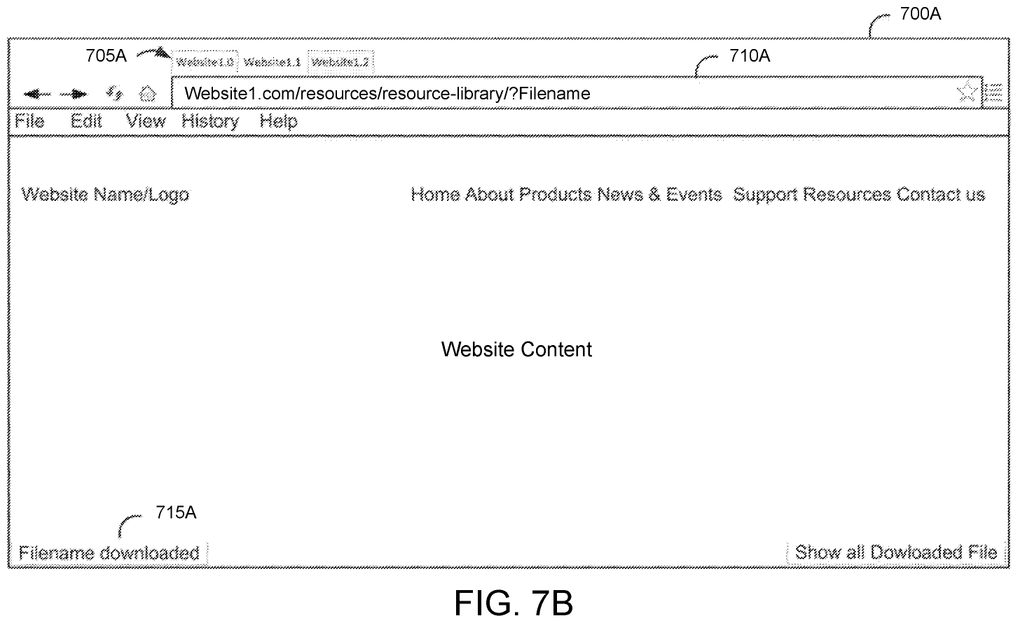

FIGS. 7A and 7B depicts two exemplary screens of a web browser screen for submitting a file query for download through a URL entry according to certain embodiments of the present disclosure. As shown in FIG. 7A, the website field 705 comprises the website that is being used to submit the query for the file download. The URL field 710 comprises the field into which the URL entry (which includes the query string) for the file download is entered. As shown in FIG. 7A, the URL entry “Website1.com/home/?Filename” includes the query string “?Filename.” Once the query is entered and a file download is completed, the file downloaded field 715 provides an indication that the requested file has been downloaded.

In comparison, the only difference as shown in FIG. 7B from FIG. 7A exists in that the URL entry in the URL field 710A is “Website1.com/resources/resource-library/?Filename”, which contains the same the query string “?Filename” but with a different file folder entry before the query symbol. In this case, given the same filename being provided in the query string, both URL entries as shown in FIGS. 7A and 7B should be directed to the same file in the file system (provided that the access of the file is granted).

A further challenge in web development projects is access restriction to a file uploaded to the internet or on a website. An admin wants a user to be able to access a file without knowing the physical location of the file. It is like going into a grocery store for eggs in which the customer can walk in and, no matter what shelf or aisle she goes to, her eggs would be there (if she has the proper access rights to them). As an example, this file may be referred to as “file_restricted_to_a_specific_user.pdf”. If this file is uploaded and that URL or file location is accessible, for instance at http://website.com/filerestrictedto.pdf, the pdf file may be downloaded even if no previous knowledge of the file existed. If a file is available on a website, usually anyone can download it. That user may share that URL with someone else and that person may download that file. In some situations, it may be desirable to restrict access to some files, and the user may not know the exact location of the file.

One present solution generates a folder accessible through a website and saves the file into that folder on the website. For example, instead of saving the web accessible file to website.com/filename.pdf, the file is saved to website.com/restrictedfolders/filename.pdf. If a user doesn't know the folder beyond the domain name, then that user cannot download the file. However, if someone shares that location, then the user would still be able to download that file.

Another present solution for restricting the file uses active directories. With active directories, a user logs in on a network. This user has access rights on the network or the active directory server and on the specific folder. Only the allowed users can access that folder. However; the user has to log in to be able to access the folder. A web-guest shouldn't need to log in; the system should automatically recognize the user. This active directory solution is effective, but requires the user to be granted access rights and to remember a user name and password.

Example embodiments of the system and methods disclosed herein include receiving a request of a file from a guest of a website, determining that the file is access restricted, and securing the file to that specific web guest via a folder that expires after a predetermined amount of time, for example, twenty-four hours. A time stamp may be set for the file for the web guest upon receiving the request. Additionally, access may be restricted from free email domains such as google.com, gmail.com, yahoo.com, among others. Access may also be restricted from import restricted countries. Export restricted countries are listed on the US state department website and change frequently. Current countries listed are: Burma, Côte d'Ivoire, Cuba, Iran, North Korea, and Syria.

According to example embodiments of the systems and methods disclosed herein, when a user requests a file, the request of that user is logged into a database. In an example embodiment, the IP address for that person and the file requested by the user is recorded. A hash code of the folder location and the folder name for the file may be created. The user may receive an address for the file location and the address may include the hash code. When the user enters the address (or clicks on a link for the address), the user download the file without logging in to a network or an active directory server. Only the file location is necessary to download the file. If the user shares that file with another user or shares the location with someone who does not have access to the file, that person who requests the download may be recorded. The other user may still access the file, but the file request is recorded. In an example embodiment, the link becomes inactive after a predetermined time period (such as 24 hours) and the user can no longer access the file.

In an example embodiment of the systems and methods of restricting file access disclosed herein, a code and a data source are used to secure the file from unwanted access. The code may be also called an application and it is the first routine that a website server runs. If a user requests to download a file, the application checks that file against the database to see if that file is access restricted. If it is access restricted, the application determines if the folder and file location exist. If the folder location and file exist, the application records the request and allows access to the file for download. The application may also check the timestamp on the folder when the file request occurs. If the request is within the predetermined time frame, the application grants access to the user to download the file. If the request is not within the predetermined time frame, the application may send a message to the user notifying the user that the file is download restricted. This prevents search bots and other search engines from mining the file location.

In an alternative embodiment, when a file request is received, the application requests an email address for the user and the file is only accessible for download by that user. In yet another alternative embodiment, the IP address of the user is recorded and the file is only accessible for download by the computer at that IP address.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

In a further aspect, the present disclosure is related to a non-transitory computer readable medium storing computer executable code. The code, when executed at a processer of a computing device, may perform the method as described above. In certain embodiments, the non-transitory computer readable medium may include, but not limited to, any physical storage media storing the application as discussed above. In certain embodiments, the non-transitory computer readable medium may be implemented as the storage device of the web server as shown in FIG. 3.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method, comprising:
providing a computing device functioning as a web server, the web server having a file system storing a plurality of files, wherein each of the files in the file system has a filename, and is designated as a public file or a non-public file, and each of the non-public files is assigned with an access level;
receiving, at the web server, a uniform resource locator (URL) entry from an internet browser, wherein the internet browser is executed on a remote computing device communicatively connected to the web server via a network;
determining whether the URL entry includes a valid query string, wherein the valid query string includes a query symbol followed by text indicating a request filename; and
in response to determining that the URL entry includes the valid query string,
querying the file system as a data source for a matching file having the request filename;
determining the matching file as either the public file or the non-public file;
in response to determining the matching file as the public file, granting access to the public file to the internet browser; and
in response to determining the matching file as the non-public file, determining the access level of the non-public file, and granting or denying access of the file to the internet browser based on the access level of the non-public file.

2. The method of claim 1, further comprising:
receiving, at the web server, a web request including a hyperlink directed to one of the files stored in the file system;
in response to receiving the web request,
determining whether the one of the files directed by the hyperlink is the public file or the non-public file;
in response to determining the one of the files is the public file, granting access of the public file; and
in response to determining the one of the files is the non-public file, denying access of the non-public file.

3. The method of claim 1, further comprising:
receiving, at the web server, an uploaded file;
storing the uploaded file as one of the files in the file system of the web server, and designating the uploaded file as the public file or the non-public file; and
in response to designating the uploaded file as the non-public file, assigning the access level to the non-public file.

4. The method of claim 3, further comprising:
in response to receiving the upload file, process the filename of the file such that the processed filename of the file is URL friendly and stable.

5. The method of claim 1, wherein for each of the files being designated as the non-public file, the access level of the non-public file is selected from one of the following levels:
(1) partially restricted, indicating that the non-public file is accessible only under one or more restricted conditions; and
(2) completely restricted, indicating that the non-public file is not accessible.

6. The method of claim 5, wherein the one or more restricted conditions include a special condition, indicating that the non-public file is accessible only by approval to a download request.

7. The method of claim 6, further comprising:
in response to determining that the non-public file is accessible under the special condition, displaying a download request form on the internet browser.

8. The method of claim 5, wherein the one or more restricted conditions include a user authentication condition, indicating that the non-public file is accessible only by an authenticated user.

9. The method of claim 8, further comprising:
in response to determining that the non-public file is accessible under the user authentication condition, displaying an authentication page on the internet browser.

10. The method of claim 5, wherein the one or more restricted conditions include a location condition, indicating that the non-public file is accessible only by a user from predetermined locations.

11. The method of claim 10, further comprising:
determining, based on location information in the URL entry, whether the user is from one of the predetermined locations;
in response to determining that the user is from the predetermined locations, granting access of the non-public file; and
in response to determining that the user is not from the predetermined locations, denying access of the non-public file.

12. A system, comprising:
a computing device functioning as a web server, the computing device comprising a processor, a storage device having a file system storing a plurality of files, and a memory storing computer executable code, wherein each of the files in the file system has a filename, and is designated as a public file or a non-public file, and each of the non-public files is assigned with an access level;
wherein the computer executable code, when executed at the processor, is configured to:
receive a uniform resource locator (URL) entry from an internet browser, wherein the internet browser is executed on a remote computing device communicatively connected to the web server via a network;
determine whether the URL entry includes a valid query string, wherein the valid query string includes a query symbol followed by text indicating a request filename; and
in response to determining that the URL entry includes the valid query string,
query the file system as a data source for a matching file having the request filename;
determine the matching file as either the public file or the non-public file;
in response to determining the matching file as the public file, grant access to the public file to the internet browser; and
in response to determining the matching file as the non-public file, determine the access level of the non-public file, and grant or deny access of the file to the internet browser based on the access level of the non-public file.

13. The system of claim 12, wherein the web server is configured to, in response to receiving a web request including a hyperlink directed to one of the files stored in the file system,
determine whether the one of the files directed by the hyperlink is the public file or the non-public file;
in response to determining the one of the files is the public file, grant access of the public file; and
in response to determining the one of the files is the non-public file, deny access of the non-public file.

14. The system of claim 12, wherein the computer executable code, when executed at the processor, is further configured to:
receive, at the web server, an uploaded file;
store the uploaded file as one of the files in the file system of the web server, and designate the uploaded file as the public file or the non-public file; and
in response to designating the uploaded file as the non-public file, assign the access level to the non-public file.

15. The system of claim 14, wherein the computer executable code, when executed at the processor, is further configured to:
in response to receiving the upload file, process the filename of the file such that the processed filename of the file is URL friendly and stable.

16. The system of claim 12, wherein for each of the files being designated as the non-public file, the access level of the non-public file is selected from one of the following levels:
(1) partially restricted, indicating that the non-public file is accessible only under one or more restricted conditions; and
(2) completely restricted, indicating that the non-public file is not accessible.

17. The system of claim 16, wherein the one or more restricted conditions include:
a special condition, indicating that the non-public file is accessible only by approval to a download request;
a user authentication condition, indicating that the non-public file is accessible only by an authenticated user; and
a location condition, indicating that the non-public file is accessible only by a user from predetermined locations.

18. The system of claim 17, wherein the computer executable code, when executed at the processor, is further configured to:
in response to determining that the non-public file is accessible under the special condition, display a download request form on the internet browser.

19. The system of claim 17, wherein the computer executable code, when executed at the processor, is further configured to:
in response to determining that the non-public file is accessible under the user authentication condition, display an authentication page on the internet browser.

20. The system of claim 17, wherein the computer executable code, when executed at the processor, is further configured to:
determine, based on location information in the URL entry, whether the user is from one of the predetermined locations;
in response to determining that the user is from the predetermined locations, grant access of the non-public file; and
in response to determining that the user is not from the predetermined locations, deny access of the non-public file.
